(19) United States
(12) Patent Application Publication
(10) Pub. No.: US 2013/0192419 A1
(43) Pub. Date: Aug. 1, 2013

(54) ENGINE STARTING DEVICE

(71) Applicants: Daisuke Mizuno, Tokyo (JP); Haruhiko Shimoji, Tokyo (JP); Koichiro Kamei, Tokyo (JP); Masami Abe, Tokyo (JP); Masahiko Kurishige, Tokyo (JP); Hiroaki Kitano, Tokyo (JP); Yuhei Tsukahara, Tokyo (JP); Masahiro Iezawa, Tokyo (JP); Kazuhiro Odahara, Tokyo (JP)

(72) Inventors: Daisuke Mizuno, Tokyo (JP); Haruhiko Shimoji, Tokyo (JP); Koichiro Kamei, Tokyo (JP); Masami Abe, Tokyo (JP); Masahiko Kurishige, Tokyo (JP); Hiroaki Kitano, Tokyo (JP); Yuhei Tsukahara, Tokyo (JP); Masahiro Iezawa, Tokyo (JP); Kazuhiro Odahara, Tokyo (JP)

(73) Assignee: Mitsubishi Electric Corporation, Tokyo (JP)

(21) Appl. No.: 13/878,488

(22) PCT Filed: Nov. 24, 2011
(86) PCT No.: PCT/JP2011/077053

§ 371 Date: Apr. 9, 2013

(30) Foreign Application Priority Data
Dec. 6, 2010 (JP) 2010-271316
Mar. 25, 2011 (JP) 2011-068334

(51) Int. Cl. F02N 11/02

(52) U.S. Cl. CPC F02N 11/02
USPC 74/7 A

(57) ABSTRACT

An engine starting device includes: a starter motor; a pinion unit coupled to an output-shaft side of the starter motor by a spline, for sliding in an axial direction; and a ring gear which meshes with a pinion gear of the pinion unit pushed out by a push-out mechanism, and receives a transmission of a rotation force of the starter motor, thereby starting an engine. The pinion unit includes, on all teeth on distal end portions in a meshing axial direction of the pinion gear meshing with the ring gear, synchronization surfaces which are a pair of surfaces parallel with the meshing axial direction, and have a thickness thinner than a tooth thickness of the pinion gear.

### TECHNICAL FIELD

The present invention relates to improvement of a meshing property between a pinion gear of a starter and a ring gear of an engine when the engine is started.

### BACKGROUND ART

In a conventional engine starting device (hereinafter referred to as starter), a start operation is carried out while an engine is stopped. Thus, a pinion gear meshes with a ring gear while the ring gear is not rotating. However, in a system for carrying out idle stop for reducing fuel consumption, a restarting property is secured by meshing the pinion gear with the ring gear even when the ring gear is rotating.

For example, at the moment when the idle stop is just started and the engine is not stopped yet, if a restart is requested, or if it is necessary to reduce a period for a restart from a stop state, while the ring gear is rotating, the ring gear is meshed in advance with the pinion gear.

In this case, as a method of meshing the pinion gear with the ring gear while the ring gear is rotating, there is known a method of meshing the pinion gear by supplying an electric power to thereby adjust the speed of the starter motor of the pinion gear so that the pinion gear is synchronized with the RPM of the ring gear (for example, refer to Patent Literature 1). Moreover, there is known a method of carrying out, by providing a mechanism for synchronization in advance, synchronization up to a predetermined difference in RPM by friction of a portion of the mechanism, and then meshing gears with each other (for example, refer to Patent Literature 2). Further, there is known a method of facilitating the meshing by devising the pinion shape (for example, refer to Patent Literature 3).

### CITATION LIST

### Patent Literature

PTL 1: JP 2002-70699 A

PTL 2: JP 2006-132343 A

PTL 3: JP 2009-168230 A

### SUMMARY OF INVENTION

### Technical Problem

However, the conventional technologies have the following problems.

The ring gear decelerates while rotating by inertia after the engine stops, and in this case, the RPM becomes zero while pulsating due to a fluctuation in torque caused by compression and expansion by pistons. Thus, for example, as described in Patent Literature 1, for synchronizing the RPMs of the ring gear and the pinion gear with each other by the engine starting device (starter), thereby meshing those gears with each other, a complex configuration is necessary. Specifically, there is a need for a complex mechanism for acquiring or predicting the RPMs of the ring gear and the pinion gear, and, based thereon, for controlling the starter to mesh the ring gear and the pinion gear with each other.

Moreover, the meshing is not realized only by the synchronization and it is necessary to realize the meshing by causing the pinion gear and the ring gear to match with each other in phase. For this reason, it is necessary to recognize the precise positions in the rotation direction for the respective synchronized gears. However, in order to carry out the highly precise control, there is a need for detectors such as highly-precise encoders, and high speed arithmetic processing in an ECU on the engine side. Moreover, regarding the detection of the phase of the pinion gear by using an encoder or the like, the pinion gear itself is a moving body, which makes the attachment of the encoder thereto difficult. Accordingly, the system becomes complex and the size of the device increases.

Further, even if a complex configuration is realized by simplification by means of a method of predicting the respective RPMs to thereby enmesh the pinion gear, the RPM difference upon the contact occurs due to errors in predicted values, and a variation in timing of enmeshing the pinion gear in the axial direction. Accordingly, precise control is difficult.

On the other hand, for example, as described in Patent Literature 2, by providing a configuration in which the pinion gear and the ring gear are synchronized in RPM by a synchronizing mechanism in advance to be then brought into contact with each other, the ring gear and the pinion gear can be synchronized with each other in RPM by a simpler configuration. However, a gear ratio of the pinion gear to the ring gear is generally present at a level of ten times for reducing the size of the motor, and the pinion gear and the ring gear are not arranged coaxially due to a restriction in terms of a dimensional configuration. Thus, the synchronization is carried out while a friction surface of the synchronization mechanism for bringing the pinion gear into contact with the ring gear is always slipping, and it is difficult to realize a complete synchronization in which the phases are matched as well.

Moreover, in the synchronization mechanism, when the ring gear and the pinion gear are in contact with each other after the synchronization, except for a case where the phases are matched with each other by chance, a slip is generated between the ring gear and the pinion gear, and the ring gear and the pinion gear mesh with each other when the phases thereof are matched. In this way, in the configuration employing the synchronization mechanism, after the synchronization is realized by the slip, the pinion gear and the ring gear are brought into contact with each other. As a result, there are a problem of noises and wear upon the contact and a problem in that a friction surface is additionally necessary for the synchronization, resulting in requirement of an additional space.

Moreover, for example, in a case where the synchronization mechanism is used, as described in Patent Literature 3, in order to facilitate the meshing between the pinion gear and the ring gear, it is conceivable to devise a shape of ends of the pinion gear, thereby providing a chamfer or the like on the tooth end. As a result, according to Patent Literature 3, a space portion realized by the chamfering can be inserted, and a guiding effect by the surface contact is realized.

On this occasion, for the meshing in a state in which the ring gear is stopped, the guiding effect by the chamfering is provided. However, in a case where a relative RPM of the pinion gear is different while the ring gear is rotating, a collision of both the gears as a result of the contact of the chamfered portions generates a force component of pushing back the pinion gear in the axial direction. As a result, there is a problem in that collision sounds and a delay in meshing occur upon the meshing.

In this way, when the pinion gear is meshed while the ring gear is rotating, the noises, a decrease in service life due to wear, and the delay in starting which is caused by a loss in the meshing time occur unless more secure synchronization and phase matching are carried out at the moment of the contact.

Particularly, in a case where the RPM difference is large when the pinion gear and the ring gear mesh with each other, the teeth are rubbed against each other and the gears are meshed while generating noises. As a result, in addition to the problem of the service life caused by the wear of the teeth or the like, there is a problem in that a torque force due to the RPM difference on the chamfered surfaces and the like acts as a force in the axial direction and hence the pinion gear is bounced back significantly so that a loss is generated in the meshing time and a restarting property also degrades.

The present invention has been made in order to solve those problem, and therefore has an object to obtain an engine starting device for carrying out, when the pinion gear and the ring gear mesh with each other while the ring gear is rotating, even if a difference in RPM exists in any one of the ring gear and the pinion gear, more reliable synchronization and phase matching immediately after the contact, and suppressing noises, a decrease in the service life caused by wear, and a delay in the starting property which is caused by a loss of the meshing time.

### Solution to Problem

According to the present invention, there is provided an engine starting device, including: a starter motor; a pinion unit which is coupled to an output-shaft side of the starter motor by means of a spline, for sliding in an axial direction; and a ring gear which has a push-out mechanism for moving the pinion unit to an engaging position with the ring gear, meshes with a pinion of the pinion unit pushed out by the push-out mechanism, and receives a transmission of a rotation force of the starter motor, thereby starting an engine, in which the pinion unit includes, on all teeth on distal end portions in a meshing axial direction of the pinion gear meshing with the ring gear, synchronization surfaces which are a pair of surfaces parallel with the meshing axial direction, and have a thickness thinner than a tooth thickness of the pinion gear.

### Advantageous Effects of Invention

In the engine starting device according to the present invention, on the distal end portions of the pinion gear, the synchronization surfaces having the thickness thinner than the tooth thickness of the pinion gear are provided, and the configuration in which the synchronization is not realized by a friction between the end surfaces of the gears, but is realized by the collision between the synchronization surfaces is provided. Therefore, when the pining gear is meshed with the ring gear while the ring gear is rotating, even if a difference in RPM exists in any one of the ring gear and the pinion gear, more secure synchronization and phase matching are instantly carried out upon the contact, thereby suppressing noises, a decreased service life due to wear, and a delay in a starting property due to loss in the meshing time.

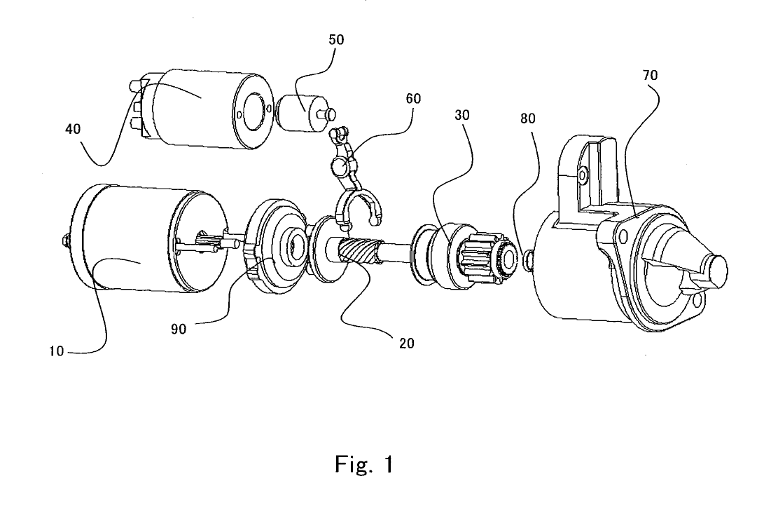

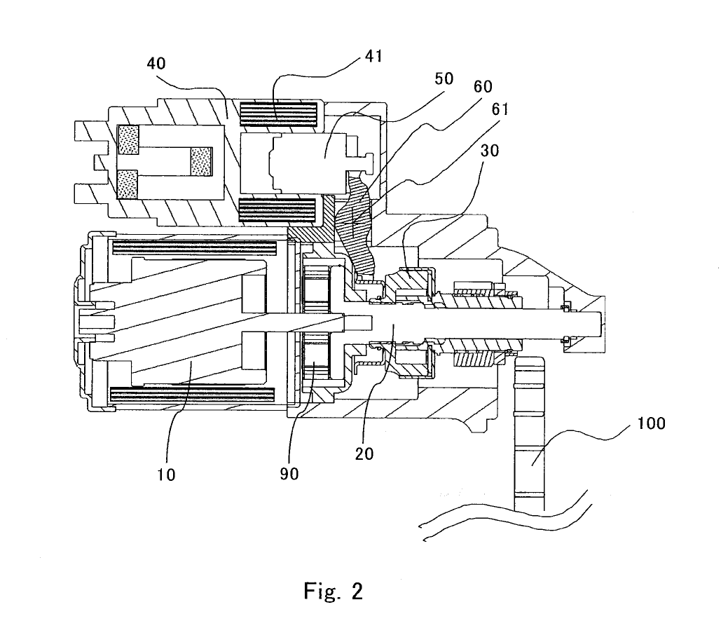

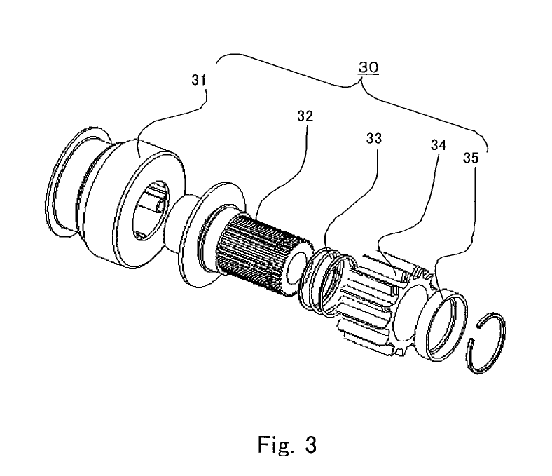

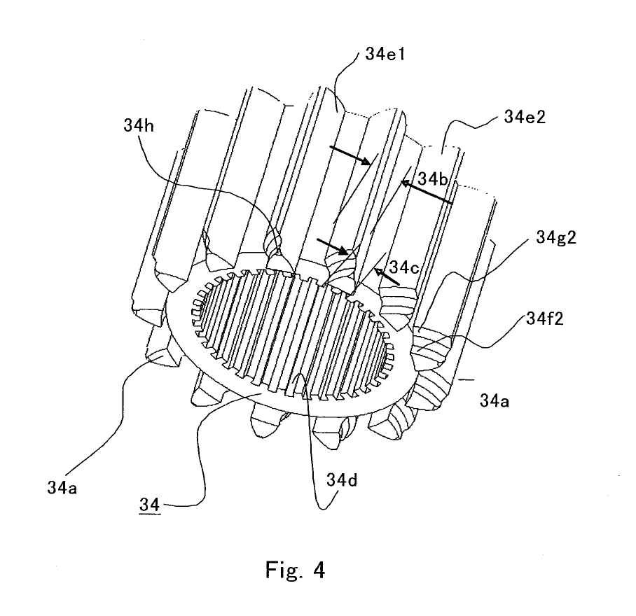

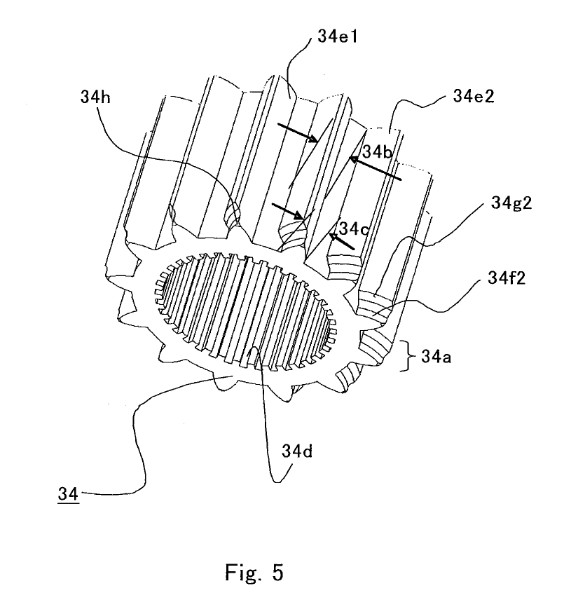

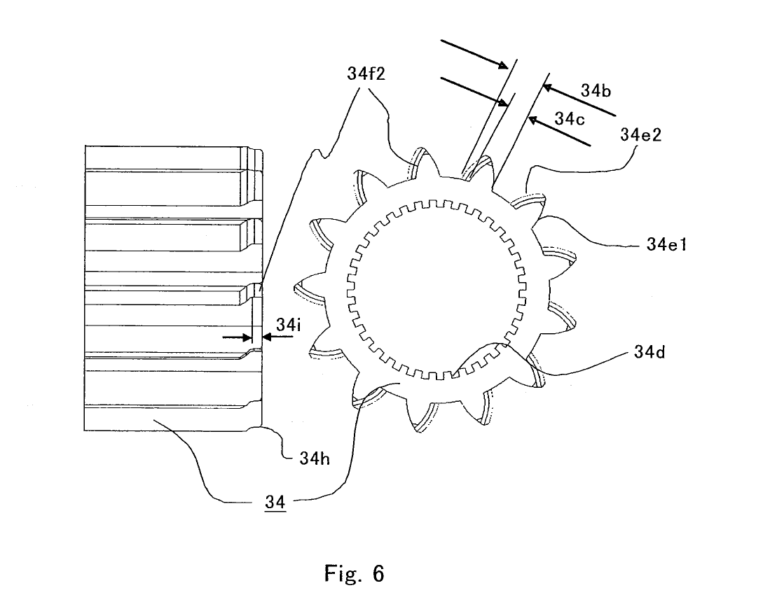

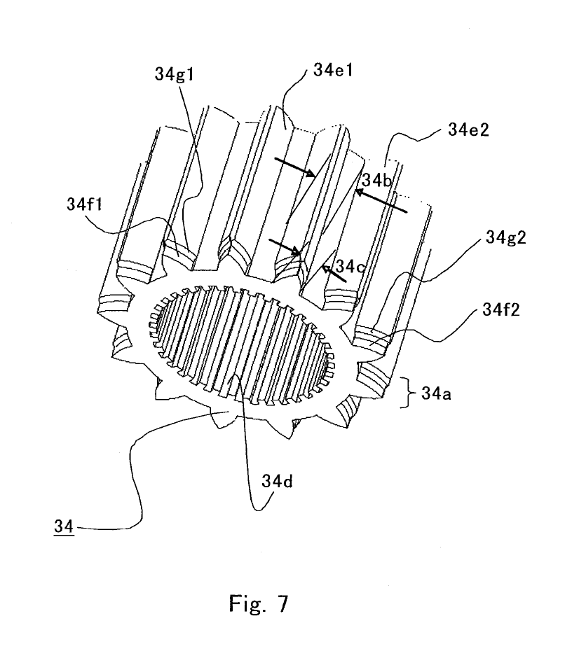

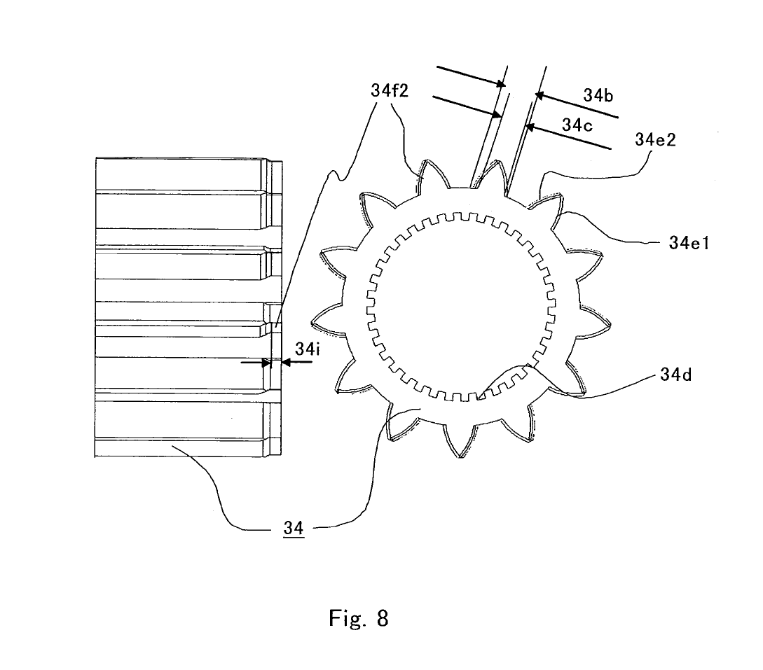

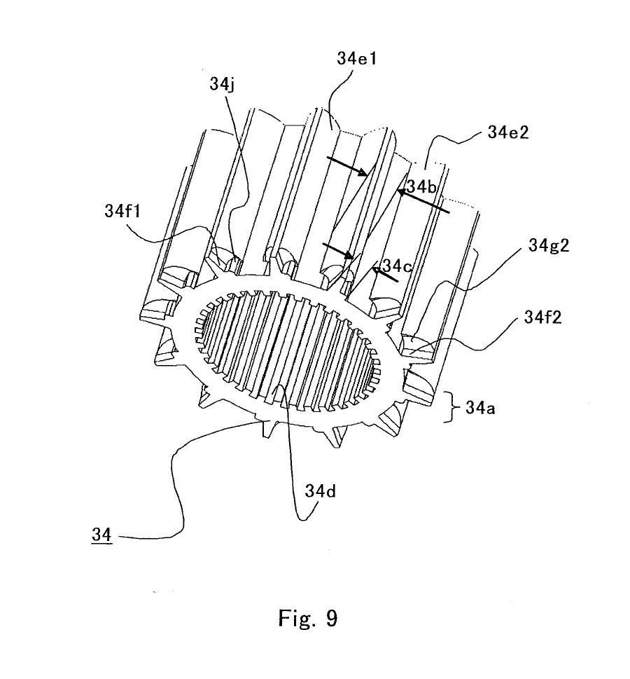

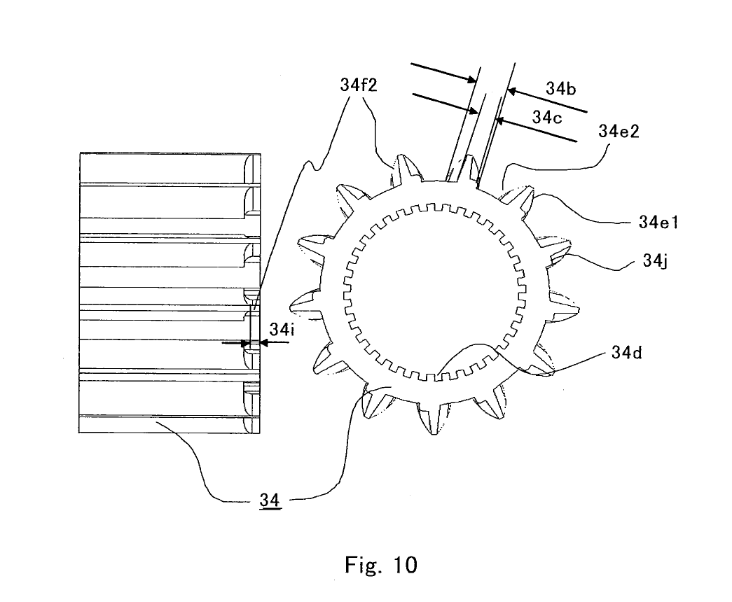

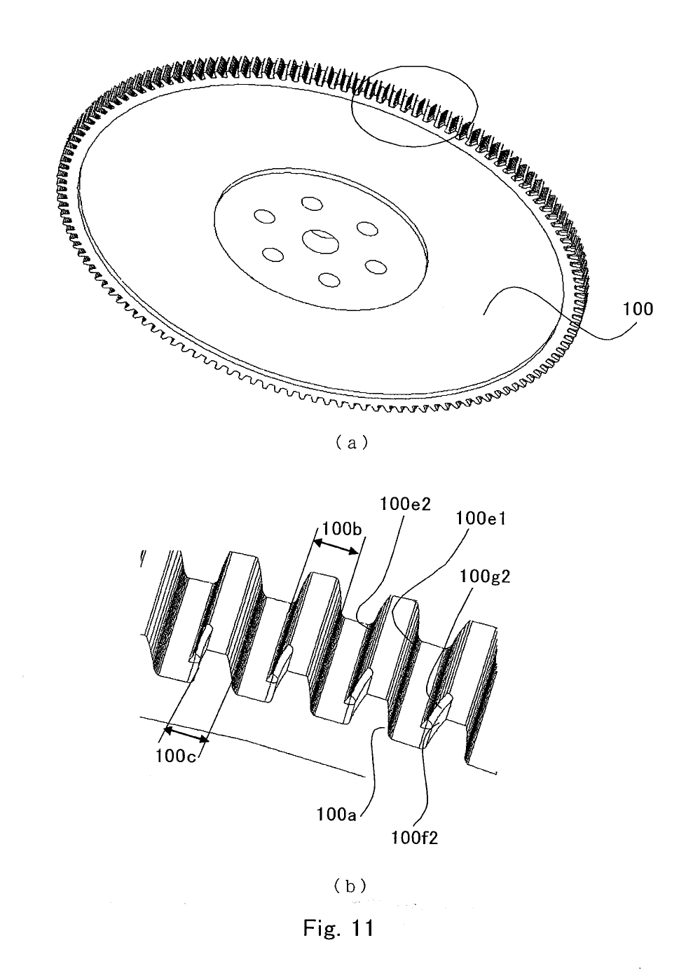

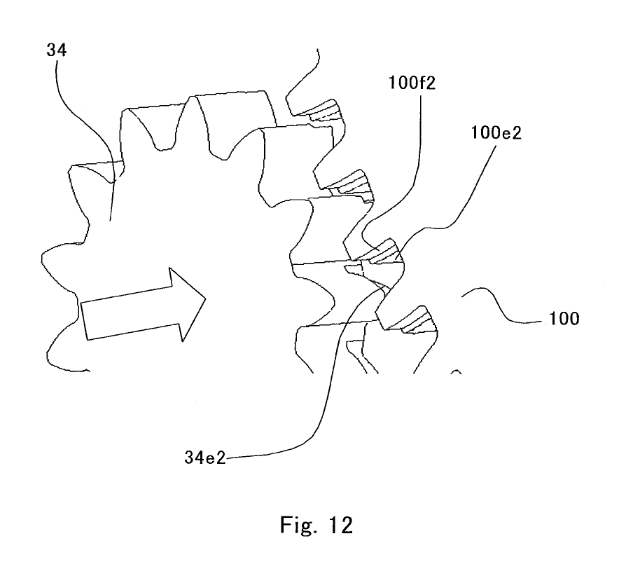

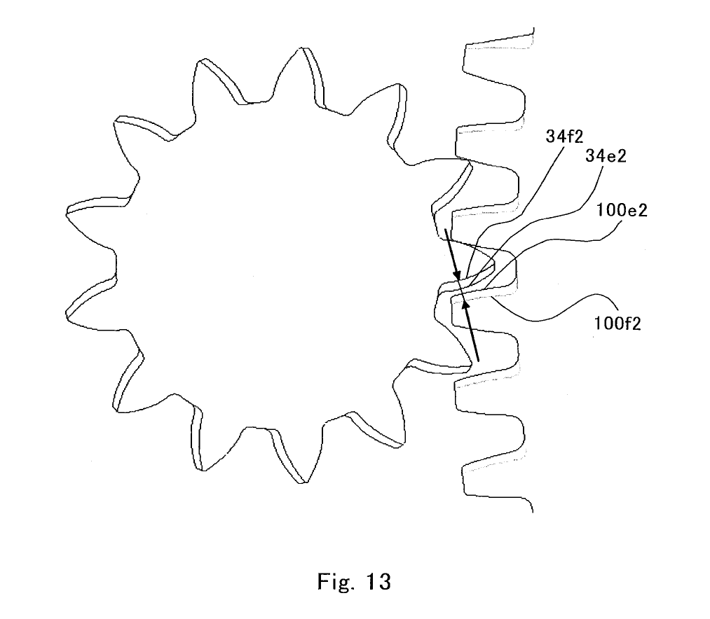

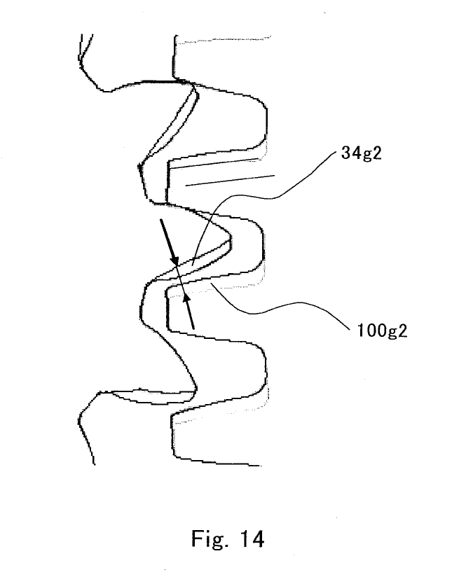

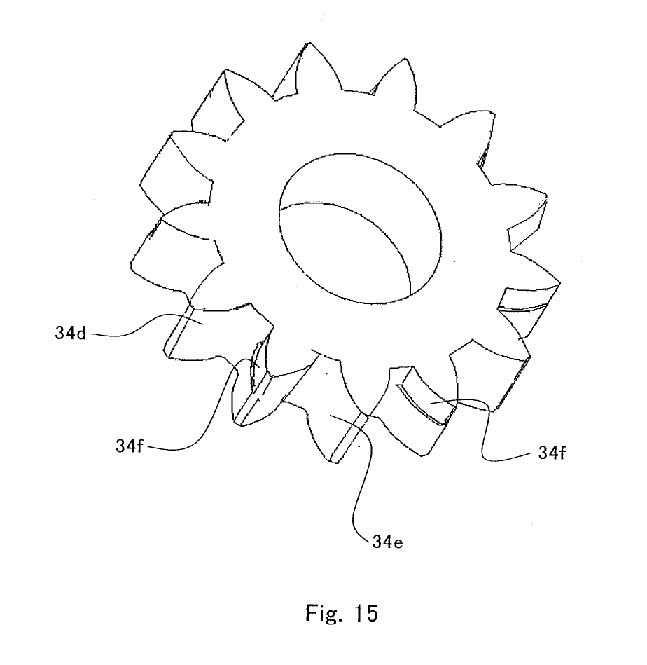

### BRIEF DESCRIPTION OF DRAWINGS

[FIG. 1] An exploded view of an engine starting device according to a first embodiment of the present invention.

[FIG. 2] A cross sectional view when the engine starting device according to the first embodiment of the present invention is installed on an engine.

[FIG. 3] An exploded perspective view of components of a pinion unit according to the first embodiment of the present invention.

[FIG. 4] A perspective view illustrating a shape of a pinion gear according to the first embodiment of the present invention.

[FIG. 5] A perspective view illustrating another shape of the pinion gear according to the first embodiment of the present invention.

[FIG. 6] A front view and a side view of the pinion gear illustrated in FIG. 5 according to the first embodiment of the present invention.

[FIG. 7] A perspective view illustrating the shape of a pinion gear according to a second embodiment of the present invention.

[FIG. 8] A front view and a side view of the pinion gear according to the second embodiment of the present invention.

[FIG. 9] A perspective view illustrating the shape of a pinion gear according to a third embodiment of the present invention.

[FIG. 10] A front view and a side view of the pinion gear according to the third embodiment of the present invention.

[FIG. 11] A perspective view and a partially enlarged view illustrating a shape of a ring gear for the engine starting device according to a fourth embodiment of the present invention.

[FIG. 12] A perspective view when distal ends of the pinion gear and the ring gear mesh with each other according to the fourth embodiment of the present invention.

[FIG. 13] A schematic view seen through in an axial direction when the distal ends of the pinion gear and the ring gear mesh with each other according to the fourth embodiment of the present invention.

[FIG. 14] A partially enlarged view of the schematic view illustrated in FIG. 13 according to the fourth embodiment of the present invention.

[FIG. 15] A perspective view illustrating the shape of a pinion gear according to a fifth embodiment of the present invention.

### DESCRIPTION OF EMBODIMENTS

A description is now given of an engine starting device according to preferred embodiments of the present invention referring to the drawings.

### First Embodiment

FIG. 1 is an exploded view of an engine starting device according to a first embodiment of the present invention. The engine starting device according to the first embodiment illustrated in FIG. 1 includes a motor drive unit 10, a shaft 20, a pinion unit 30, an attraction coil unit 40, a plunger 50, a lever 60, a bracket 70, a stopper 80, and a speed reduction gear unit 90.

The motor drive unit 10 starts an engine. The shaft 20 is coupled via the speed reduction gear unit 90 to an output-shaft side of the motor. The pinion unit 30 is integrated with an overrunning clutch coupled to the shaft 20 by means of a helical spline, and can slide in the axial direction.

The attraction coil unit 40 attracts the plunger 50 by a switch being turned on. The lever 60 transmits a travel of the plunger 50 by the attraction to the pinion unit 30. The bracket 70 fixes the respective components including the motor drive unit 10, the shaft 20, and the pinion unit 30 via the stopper 80 to the engine side when the pinion travels.

FIG. 2 is a cross sectional view when the engine starting device according to the first embodiment of the present invention is installed on the engine. In a case where the engine is to be started, when the switch is turned on, a relay contact closes and a current flows through an attraction coil 41 of the attraction coil unit 40. Accordingly, the plunger 50 is attracted. When the plunger 50 is attracted, the lever 60 is pulled in, and the lever 60 rotates about a lever rotation axial center 61.

In the rotated lever 60, an end portion of the opposite side of the plunger 50 pushes out the pinion unit 30 and, as a result, the pinion unit 30 is pushed out along the spline of the shaft 20 while rotating.

FIG. 3 is an exploded perspective view of components of the pinion unit 30 according to the first embodiment of the present invention. The pinion unit 30 includes an overrunning clutch 31, a shaft core 32, a coil spring 33, a pinion gear 34, and a retaining component 35.

FIG. 4 is a perspective view illustrating a shape of the pinion gear 34 according to the first embodiment of the present invention. The respective reference numerals of FIG. 4 denote the following contents.

34a: A distal end portion for meshing provided on an end surface portion on a ring gear 100 side of the pinion gear 34

34b: A tooth thickness of the pinion gear 34

34c: A tooth thickness of the distal end portion 34a

34d: A groove for meshing of the pinion gear 34

34e1: A surface on a torque transmission side of a tooth of the pinion gear 34

34e2: A surface on a torque non-transmission side of the tooth of the pinion gear 34

34f2: A synchronization surface on the torque non-transmission side of the distal end portion 34a

34g2: A chamfered portion of a step between the synchronization surface

34f2 on the torque non-transmission side of the distal end portion 34a and the surface 34e2 on the torque non-transmission side of the tooth

34h: A chamfer on a tooth-tip-outer-diameter portion of the distal end portion 34a

As illustrated in FIG. 4, on the end surface of the pinion gear 34 on the ring gear 100 side, the distal end portion 34a in a shape protruding toward the ring gear 100 side exists on a distal end of each tooth. On this occasion, a surface on the torque transmission side of the distal end portion 34a illustrated in FIG. 4 is the same surface as the surface 34e1 on the torque transmission side of the tooth of the pinion gear 34.

In contrast, the surface on the torque non-transmission side of the distal end portion 34a has a step to the surface 34e2 on the torque non-transmission side of the tooth of the pinion gear 34. In other words, as a surface acquired by displacing the surface 34e2 on the torque non-transmission side of the tooth of the pinion gear 34, the synchronization surface 34f2 on the torque non-transmission side of the distal end portion 34a exists.

Then, on the step between the surface 34e2 on the torque non-transmission side of the tooth of the pinion gear 34 and the synchronization surface 34f2 on the torque non-transmission side of the distal end portion 34a, the chamfered portion 34g2 exists. The tooth thickness 34c of the distal end portion 34a is smaller than the tooth thickness 34b of the pinion gear 34.

On the other hand, FIG. 5 is a perspective view illustrating another shape of the pinion gear 34 according to the first embodiment of the present invention. In the above-mentioned FIG. 4, the distal end portion 34a is in the shape protruding toward the ring gear 100 side. However, as illustrated in FIG. 5, such a configuration that, without having the protruding shape, the end surface of the distal end portion 34a is coupled so as to be coplanar with the pinion gear end surface on the ring gear side does not pose a problem. The configuration illustrated in FIG. 5 can simplify manufacturing of the pinion gear 34, thereby suppressing a cost.

The above-mentioned shape including the distal end portions 34a illustrated in FIG. 4 or 5 results in a displaced two-stage pinion gear having two specifications for the pinion gear 34. In other words, the pinion gear has the two-stage structure including the portion having the tooth thickness 34b of the pinion gear 34 after the meshing and the portion having the tooth thickness 34c (on this occasion, there is a relationship where the tooth thickness 34c is thinner than the tooth thickness 34b) of the distal end portions 34a for initially meshing with the ring gear 100.

In the pinion gear unit on the first stage having the distal end portions 34a, on the distal end portion 34a of the pinion gear 34, except for the chamfer 34h on the tooth-tip-outer-diameter portion required for manufacturing, no chamfers exist, and the tooth is constituted of surfaces parallel with the axial direction. The parallelism on this occasion is defined as parallelism where an angle at a level of crowning can be neglected.

A case where the ring gear 100 is rotating, and the RPM of the ring gear 100 is higher than the RPM of the pinion gear 34 is now considered. In this case, when the coil 41 is supplied with electric power by a switch, thereby pulling in the plunger 50, and the pinion unit 30 is pushed out via the lever 60, the pinion gear 34 upon the contact with the ring gear 100 collides at the two surfaces, which are the side surface portion and the synchronization surface 34f2 on the torque non-transmission side of the distal end portion 34a of the pinion gear 34 constituted of the parallel surfaces.

On the pinion gear 34, the meshing grooves 34d are formed. Thus, when the collision occurs on the side surface portion, the pinion gear 34 retracts along grooves formed on the shaft core 32, and the coil spring 33 contracts. On this occasion, a damper effect shifts the phase of the next tooth, and the contact continues to an angle and for phase permitting the insertion.

Further, when the collision against the synchronization surface 34f2 on the torque non-transmission side of the distal end portions 34a is occurred, a torque force caused by the RPM difference between the ring gear 100 and the pinion gear 34 does not have a component in the axial direction and thus constitutes a rotation force of the pinion gear 34, and hence a meshing occurs in a direction for establishing the synchronization. Thus, even if there is an RPM difference between the ring gear 100 and the pinion gear 34, by employing the pinion gear 34 having the two-stage structure, the pinion gear 34 is prevented from being bounced back, and the meshing is attained.

In contrast, if a pinion gear which does not have the two-stage structure, and thus does not have the synchronization surfaces 34f2 on the torque non-transmission side and the chamfered portions 34g2 of the distal end portions 34a is brought in contact with the ring gear 100 when there is an RPM difference between the ring gear 100 and the pinion gear, meshing hardly occurs. This is because, in order to secure a meshing rate after the meshing, an amount of the backlash between the pinion gear and the ring gear 100 is restricted, the normal amount of the backlash cannot bring the teeth of the ring gear 100 into contact with the surfaces 34e2 on the torque non-transmission side of the teeth of the pinion gear 34, and, while the contact is made on the side surfaces, a scratching state continues until the synchronization.

On the other hand, according to the present invention, the predetermined amount of the backlash suitable for the meshing is provided for the distal end portions 34a which are irrelevant to the meshing (namely, the pinion gear portion on the first stage), thereby achieving the meshing of the pinion gear 34 without being bounced back. FIG. 6 illustrates a front view and a side view of the pinion gear 34 illustrated in FIG. 5 according to the first embodiment of the present invention. A depth dimension 34i in the axial direction of the synchronization surface 34f2 on the torque non-transmission side of the distal end portion 34a illustrated in FIG. 6 only needs to secure a surface depth so that a torque is applied only for meshing the ring gear 100 and the pinion gear 34 with each other, thereby rotating the one-way clutch.

Therefore, the employment of the pinion gear 34 according to the present invention prevents the pinion gear 34 being bounced back, thereby enabling instantaneous meshing between the pinion gear 34 and the ring gear 100. Specifically, conventional chamfers enable the meshing at the RPM difference at a level of equal to or less than 50 rpm. In contrast, according to the present invention, it has been confirmed that, only by changing the pinion gear 34 to have the shape in the two-stage structure, the meshing is enabled even when there is an RPM difference at a level of 300 rpm.

As described above, according to the first embodiment, on the distal end portions of the pinion gear, the synchronization surfaces (pinion gear portion synchronization surfaces) having the thickness thinner than the tooth thickness of the pinion gear are provided, and the two-stage structure which does not attain the synchronization by the friction between the end surfaces of the gears, but attains the synchronization by the collision of the tooth surfaces is provided. Accordingly, when the pinion gear and the ring gear are meshed with each other while the ring gear is rotating, irrespective of whether the RPM difference exists on the ring gear or the pinion gear, more secure synchronization and phase matching can be instantaneously carried out upon the contact. As a result, an engine starting device for suppressing noises, a decreased service life due to wears, and a delay of a starting property due to a loss in the meshing time can be realized without an increase in cost.

### Second Embodiment

In the above-mentioned first embodiment, a description has been given of the configuration in which the synchronization surface 34f2 and the chamfered portion 34g2 are provided only on the surface on the torque non-transmission side of the distal end portion 34a, and the surface on the torque transmission side is the same surface. In contrast, in a second embodiment of the present invention, a description is given of such a configuration that, in addition to the surface on the torque non-transmission side, on the surface on the torque transmission side, a synchronization surface and a chamfered portion are provided.

FIG. 7 is a perspective view illustrating a shape of a pinion gear 34 according to the second embodiment of the present invention. Note that, the structure and operation for pushing out the pinion unit 30 are the same as those of the above-mentioned first embodiment, and descriptions thereof are therefore omitted.

The respective reference numerals of FIG. 7 denote the following contents.

34a: A distal end portion for meshing provided on an end surface portion on the ring gear 100 side of the pinion gear 34

34b: A tooth thickness of the pinion gear 34

34c: A tooth thickness of the distal end portion 34a

34d: A groove for meshing of the pinion gear 34

34e1: A surface on a torque transmission side of a tooth of the pinion gear 34

34e2: A surface on a torque non-transmission side of the tooth of the pinion gear 34

34f1: A synchronization surface on the torque transmission side of the distal end portion 34a

34f2: A synchronization surface on the torque non-transmission side of the distal end portion 34a

34g1: A chamfered portion of a step between the synchronization surface 34f1 on the torque transmission side of the distal end portion 34a and the surface 34e1 on the torque transmission side of the tooth

34g2: A chamfered portion of a step between the synchronization surface 34f2 on the torque non-transmission side of the distal end portion 34a and the surface 34e2 on the torque non-transmission side of the tooth

The shape of the pinion gear 34 according to the second embodiment illustrated in FIG. 7 includes, as in the above-mentioned first embodiment, on the surface on the torque non-transmission side of the distal end portion 34a, the synchronization surface 34f2 and the chamfered portion 34g2. Further, according to the second embodiment, the surface on the torque transmission side of the distal end portion 34a also includes the synchronization surface 34f1 and the chamfered portion 34g1. In other words, also on the surface on the torque transmission side, as the two-stage structure provided with the step, and as a surface acquired by displacing the surface 34e1 on the torque transmission side of the tooth of the pinion gear 34, the synchronization surface 34f1 on the torque transmission side of the distal end portion 34a exists.

In this way, by providing the step also on the surface on the torque transmission side, such a structure that, when the ring gear 100 and the pinion gear 34 completely mesh with each other, and an excessive torque is applied, the load is not applied to the thinner location of the distal end portion 34a is provided. On this occasion, the step of the pinion gear 34 on the surface on the torque transmission side is a step which does not activate the one-way clutch, and hence the step as well as a tolerance thereof is preferably minimized.

FIG. 8 is a front view and a side view of the pinion gear 34 according to the second embodiment of the present invention. The tooth thickness 34c of the distal end portion 34a is thinner than the tooth thickness 34b of the pinion gear 34, which is the torque transmission portion, and, as illustrated in FIG. 8, is also decentralized toward the torque transmission side. The decentralized structure can minimize the step of the pinion gear 34 on the surface on the torque transmission side, thereby suppressing a wear caused by the step to the minimum.

Moreover, the depth dimension 34i in the axial direction of the synchronization surface 34f2 on the torque non-transmission side of the distal end portion 34a illustrated in FIG. 8 only needs to secure a surface depth so that a torque is applied only for meshing the ring gear 100 and the pinion gear 34 with each other, thereby rotating the one-way clutch.

As described above, according to the second embodiment, on the distal end portions of the pinion gear, the synchronization surfaces having the thickness thinner than the tooth thickness of the pinion gear are provided, and the two-stage structure which does not attain the synchronization by the friction between the end surfaces of the gears, but attains the synchronization by the collision of the tooth surfaces is provided. Accordingly, when the pinion gear and the ring gear are meshed with each other while the ring gear is rotating, irrespective of whether the RPM difference exists on the ring gear or the pinion gear, more secure synchronization and phase matching can be instantaneously carried out upon the contact. As a result, an engine starting device for suppressing noises, a decrease in the service life due to wears, and a delay of a starting property due to a loss in the meshing time can be realized without an increase in cost.

Further, a two-stage structure in which, in addition to the surface on the toque-non-transmission side, on the surface on the torque transmission side, the synchronization surface and the chamfered portion are provided is realized. In this way, by providing the step also on the surface on the torque transmission side, such a structure that, when the ring gear and the pinion gear completely mesh with each other, and an excessive torque is applied, the load is not applied to the thinner locations of the distal end portions is provided. Further, the decentralized structure is provided between the step on the surface on the torque non-transmission side and the step on the surface on the torque transmission side, and hence the step of the pinion gear on the surface on the torque transmission side can be minimized, and the wear caused by the step can be suppressed to the minimum as well.

### Third Embodiment

In the above-mentioned first and second embodiments, a description has been given of the case where any of the shape of the distal end portion 34a of the pinion gear 34 is constituted of the tooth. In contrast, according to a third embodiment of the present invention, the shapes of the distal end portions 34a of the pinion gear 34 are constituted of as many protrusions as the teeth.

FIG. 9 is a perspective view illustrating a shape of a pinion gear 34 according to the third embodiment of the present invention. Note that, the structure and operation for pushing out the pinion unit 30 are the same as those of the above-mentioned first and second embodiments, and descriptions thereof are therefore omitted.

The respective reference numerals of FIG. 9 denote the following contents.

34a: A distal end portion for meshing provided on an end surface portion on the ring gear 100 side of the pinion gear 34

34b: A tooth thickness of the pinion gear 34

34c: A tooth thickness of the distal end portion 34a

34d: A groove for meshing of the pinion gear 34

34e1: A surface on a torque transmission side of a tooth of the pinion gear 34

34e2: A surface on a torque non-transmission side of the tooth of the pinion gear 34

34f1: A synchronization surface on the torque transmission side of the distal end portion 34a

34f2: A synchronization surface on the torque non-transmission side of the distal end portion 34a

34g2: A chamfered portion of a step between the synchronization surface

34f2 on the torque non-transmission side of the distal end portion 34a and the surface 34e2 on the torque non-transmission side of the tooth

34j: A widthwise protruded portion provided at a bottom of the surface on the torque transmission side of the distal end portion 34a

In the shape of the pinion gear 34 illustrated in FIG. 9, the distal end portion 34a is constituted not of the tooth, but of each of as many protrusions as the teeth, and the widthwise protruded portion 34j provided at the bottom of the protrusion on the surface on the torque transmission side. The shape of the distal end portion 34a according to the third embodiment is irrelevant to a general tooth such as an involute tooth profile, and the area of the protrusion is constituted of an area smaller than the cross section of the tooth. Further, the third embodiment includes, as in the above-mentioned first and second embodiments, as the surfaces parallel with the axial direction, the synchronization surfaces 34f1 and 34f2.

In this way, with respect to a gap of the ring gear 100, the size (34c) of the protruded portion of the distal end portion 34a is constituted so as to be smaller than the size (34b) of the pinion gear 34, and hence when a collision occurs on the synchronization surfaces 34f1 and 34f2 of the protruded portion, the RPM almost match. Thus, the same effects as those of the above-mentioned first and second embodiments are acquired.

FIG. 10 is a front view and a side view of the pinion gear 34 according to the third embodiment of the present invention. The tooth thickness 34c of the distal end portion 34a is thinner than the tooth thickness 34b of the pinion gear 34, which is the torque transmission portion, and, as illustrated in FIG. 10, is also decentralized toward the torque transmission side. Even in the case where the shapes of the distal end portions 34a are constituted of as many protrusions as the teeth, as in the above-mentioned second embodiment, the decentralized structure can minimize the step of the pinion gear 34 on the surface on the torque transmission side, thereby suppressing a wear caused by the step to the minimum.

Moreover, the depth dimension 34i in the axial direction of the synchronization surface 34f2 on the torque non-transmission side of the distal end portion 34a illustrated in FIG. 10 only needs to secure a surface depth so that a torque is applied only for meshing the ring gear 100 and the pinion gear 34 with each other, thereby rotating the one-way clutch.

As described above, according to the third embodiment, also by constituting the shape of the distal end portion of the pinion gear of each of as many protrusions as the teeth, as in the above-mentioned first and second embodiments, an engine starting device for suppressing noises, a decrease in the service life due to wears, and a delay of a starting property due to a loss in the meshing time can be realized without an increase in cost.

Note that, the mechanism for pushing out the pinion unit 30 is not limited to the mechanism illustrated in FIGS. 1 and 2 in the above-mentioned first embodiment. Other mechanism such as a means for pushing out the pinion unit 30 in the axial direction by using a drive force of a motor may be employed, and the same effect can be provided.

### Fourth Embodiment

According to the above-mentioned first to third embodiments, a description has been given of the case where, by devising the shape of the distal end portions 34a of the pinion gear 34, the predetermined amount of the backlash suitable for the meshing is provided, thereby increasing the amount of the backlash. In contrast, according to a fourth embodiment of the present invention, a description is given of a method of acquiring a further effect, by similarly devising a distal end shape of the ring gear 100, thereby increasing the amount of the backlash.

FIGS. 11 are a perspective view and a partially enlarged view illustrating the shape of the ring gear 100 for the engine starting device according to the fourth embodiment of the present invention. The engine starting device on the pinion gear side is the same as that of the above-mentioned first, second, or third embodiment. Thus, an operation method for the engine starting device on the pinion gear side is also the same as that of the above-mentioned first, second, or third embodiment.

The distal end shape of the pinion gear 34 is thinner in the tooth thickness direction so as to increase the backlash. Note that, the pinion distal end shape according to the third embodiment is not involute, and the definition of the backlash is thus not apparent, but the minimum distance in a play space in the rotation direction between the pinion gear 34 and the ring gear 100 is considered as a value corresponding to the “backlash”.

By further increasing the backlash amount, it is expected that the easiness of the insertion be further improved. However, the direction of increasing the backlash amount by the shape of the pinion gear 34 corresponds to a direction of decreasing the tooth thickness of the pinion gear 34, and hence the increase of the backlash amount decreases the strength of the pinion gear 34.

Thus, the fourth embodiment provides a solution by similarly providing, while the strength of the pinion gear 34 is maintained, in order to increase the backlash amount, the ring gear 100 with surfaces which are parallel with the tooth surfaces after the meshing, and have a small tooth thickness.

Specifically, as illustrated in a partially enlarged view of FIG. 11(b), it is conceivable to devise the shape of the ring gear 100. On this occasion, respective reference numerals of FIG. 11(b) denote the following contents.

100a: A distal end portion for meshing

100b: A tooth thickness of the ring gear 100

100c: A tooth thickness of the distal end portion 100a of the ring gear 100

100e1: A surface on a torque transmission side of a tooth of the ring gear 100

100e2: A surface on a torque non-transmission side of the tooth of the ring gear 100

100f2: A synchronization surface on the torque non-transmission side of the distal end portion 100a of the ring gear 100

100g2: A chamfered portion of a step between the synchronization surface 100f2 on the torque non-transmission side of the distal end portion 100a and the surface 100e2 on the torque non-transmission side of the tooth

FIG. 12 is a perspective view when the distal ends of the pinion gear 34 and the ring gear 100 mesh with each other according to the fourth embodiment of the present invention. FIG. 13 is a schematic view seen through in the axial direction when the distal ends of the pinion gear 34 and the ring gear 100 mesh with each other according to the fourth embodiment of the present invention.

The amount of the backlash when the pinion gear is pushed in, and the distal end portions 34a are pushed in is a clearance between the synchronization surface 34f2 on the torque non-transmission side of the pinion gear 34 and the synchronization surface 100f2 on the torque non-transmission side of the ring gear 100. On this occasion, in order to provide the backlash amount only by the pinion gear, it is necessary to further decrease the tooth thickness of the distal end portions 34a. However, in this case, the tooth thickness of the pinion gear becomes too thin, and hence when the pinion gear 34 and the ring gear 100 collide with each other, the distal end portions 34a of the pinion gear 34 may be damaged due to an insufficient strength.

In contrast, instead of further decreasing the thickness of the distal end portions 34a of the pinion gear 34 side, as illustrated in FIG. 11(b), by decreasing the thickness of the distal end portions 100a of the ring gear 100 side, while the respective strengths of the pinion gear 34 and the ring gear 100 are maintained, the meshing property can be improved. As a result, while only by the pinion gear, the backlash amount is at the level of 1.5 times of that for the meshing between both the torque transmission surfaces, by also decreasing the thickness of the distal end shape on the ring gear 100 side, a backlash amount at a level of 3 times is provided.

Moreover, by providing such a configuration that only the thickness of the distal end shape on the ring gear 100 side is decreased, and the thickness of the distal end shape on the pinion gear 34 side is not decreased, the same effect as that provided by decreasing only the thickness of the distal end shape of the pinion gear 34, thereby increasing the backlash amount is provided, and hence a backlash amount at a level of 1.5 times can be provided.

FIG. 14 is a partially enlarged view of the schematic view illustrated in FIG. 13 according to the fourth embodiment of the present invention. As illustrated in FIG. 14, the surface 100e2 on the torque non-transmission side of the distal end portion 100a of the ring gear 100 is not necessarily a tooth surface such as an involute surface, and a shape for reinforcing a neighborhood of the bottom of the tooth can be employed.

As described above, according to the fourth embodiment, on the distal end portions of the ring gear, the synchronization surfaces (ring gear portion synchronization surfaces) having the thickness thinner than the tooth thickness of the ring gear are provided, and the two-stage structure which does not attain the synchronization by the friction between the end surfaces of the gears, but attains the synchronization by the collision of the tooth surfaces is provided. As a result, when the pinion gear and the ring gear are meshed with each other while the ring gear is rotating, irrespective of whether the RPM difference exists on the ring gear or the pinion gear, more secure synchronization and phase matching can be instantaneously carried out upon the contact.

Further, by using both the synchronization surface on the ring gear side and the synchronization surface on the pinion gear side, the backlash amount between both the distal end portions at the beginning of the meshing can be larger than the backlash amount after the meshing, thereby, in terms of secure synchronization and instantaneous phase matching, providing higher efficiency. As a result, an engine starting device for suppressing noises, a decrease in the service life due to wears, and a delay of a starting property due to a loss in the meshing time can be realized without an increase in cost.

By inclining the synchronization surface on the pinion gear side and the synchronization surface on the ring gear side described above in the above-mentioned first to fourth embodiments to a level which does not exceed the pinion gear push out force, more secure synchronization and phase matching can be carried out at the moment of the contact.

### Fifth Embodiment

According to the above-mentioned first to fourth embodiments, a description has been given of the case where, by devising the shape of the distal end portion 34a of the pinion gear 34, the predetermined amount of the backlash suitable for the meshing is provided, thereby increasing the amount of the backlash, which is enabled by applying the backlash amount to all the teeth. In contrast, according to a fifth embodiment of the present invention, a description is given of a case where the amount of the backlash is irregularly increased, thereby securing a strength.

FIG. 15 is a perspective view illustrating a shape of a pinion gear according to the fifth embodiment of the present invention. FIG. 15 exemplifies a case where the synchronization surface 34f having a thinner tooth thickness of the pinion gear and a synchronization surface 34e which does not have the synchronization surface 34f, and is the same surface as the torque transmission surface are alternately arranged. In other words, the pinion gear 34 according to the fifth embodiment has such a shape that some distal end portions have the tooth thickness which is not decreased and remains thick.

Even if the tooth thickness remains thick, the surface 34e is a surface in the axial direction, and, even when the ring gear 100 collides, is not bounced back. Further, some of the mixed teeth of the pinion gear 34 have the synchronization surface 34f thinner in tooth thickness, and hence there are locations having the backlash amount suitable for the meshing, and, by an amount corresponding to the locations, the meshing is promoted.

As described above, according to the fifth embodiment, the pinion gear is formed in a manner where the teeth maintaining the tooth thickness and the teeth having the thinner thickness simultaneously exist. Therefore, in terms of the teeth of the pinion gear initially colliding with the ring gear, the number of times of collisions of the ring gear with the teeth of the pinion gear having the thinner tooth thickness reduces in terms of probability. As a result, if the pinion gear is repeatedly used, the service life of the pinion gear extends, resulting in an increase in durability. Then, if the inertia on the engine side is large and the impact by the collision is large, while the service life of the pinion gear is maintained, the meshing property can be improved.

1. An engine starting device, comprising:
a starter motor;
a pinion unit which is coupled to an output-shaft side of the starter motor by means of a spline, for sliding in an axial direction;
a push-out mechanism for moving the pinion unit to an engaging position with the ring gear; and
a ring gear which meshes with a pinion gear of the pinion unit pushed out by the push-out mechanism, and receives a transmission of a rotation force of the starter motor, thereby starting an engine,
wherein the pinion unit includes, on all teeth on distal end portions in a meshing axial direction of the pinion gear meshing with the ring gear, pinion unit synchronization surfaces which are a pair of surfaces parallel with the meshing axial direction, and have a thickness thinner than a tooth thickness of the pinion gear.

2. An engine starting device according to claim 1, wherein, in a cross section in a direction perpendicular to the meshing axial direction, an cross sectional area of the pinion unit synchronization surfaces provided on the distal end portions is included in an cross sectional area of a tooth of the pinion unit, and is smaller than the cross sectional area of the tooth.

3. An engine starting device according to claim 1, wherein the pinion unit synchronization surfaces provided on the distal end portion are coupled so that an end surface on the ring gear side is coplanar with an end surface on the ring gear side of the pinion gear.

4. An engine starting device according to claim 1, wherein the pinion gear is provided with, by an amount of displacement or a pressure angle of a meshing portion of the pinion gear, the distal end portion having a tooth thickness smaller than a tooth thickness of the pinion gear after the meshing, thereby providing a two-stage structure of a specification of the tooth

5. An engine starting device according to claim 4, wherein the distal end portion increases a backlash against the ring gear by reducing a tooth-tip outer diameter.

6. An engine starting device according to claim 4, wherein a tooth shape of the distal end portion only has, as a surface of the pinion unit for generating a force of an axial direction component as a result of a collision in a rotational direction against the ring gear, a machined surface of a tooth-tip-outer-diameter-edge portion and an end surface.

7. An engine starting device according to claim 1, wherein the pinion unit synchronization surfaces provided on the distal end portion have a surface shape on a torque transmission side which is the same as a surface on the torque transmission side of the tooth of the pinion gear, and a surface shape on a torque non-transmission side which is not the same as a surface on the torque non-transmission side of the tooth of the pinion gear, but has a step.

8. An engine starting device according to claim 1, wherein the distal end portion is configured so that, out of the pinion unit synchronization surfaces, a surface shape on a torque transmission side has a first step which is not the same as a surface on the torque transmission side of the tooth of the pinion gear, a surface shape on a torque non-transmission side has a second step which is not the same as a surface on the torque non-transmission side of the tooth of the pinion gear, the first step is smaller than the second step, and, to the pinion unit synchronization surfaces of the distal end portions, a motor torque force is prevented from forming transmitted after the pinion gear meshes with the ring gear.

9. An engine starting device according to claim 1, wherein the pinion unit is configured so that, out of the pinion gear and a shaft core of the pinion unit, only the pinion gear is movable in an axial direction, and coupling in the axial direction is fixed by a spring.

10. An engine starting device according to claim 1, wherein the ring gear includes, on all teeth on distal end portions meshing with the pinion gear, ring gear unit synchronization surfaces which are a pair of surfaces parallel with the meshing axial direction, and have a thickness thinner than a tooth thickness of the ring gear.

11. An engine starting device according to claim 10, wherein the pinion unit synchronization surfaces have, in place of having the thickness thinner than the tooth thickness of the pinion gear, the same thickness as the tooth thickness of the pinion gear.

12. An engine starting device according to claim 1, wherein an amount of a backlash between predetermined surfaces on the distal end portions at a beginning of the meshing between the ring gear and the pinion gear is equal to or more than 1.5 times of an amount of the backlash after the meshing.

13. An engine starting device according to claim 1, wherein the pinion gear unit synchronization surfaces and the ring gear unit synchronization surfaces are inclined to a level equal to less than a pinion gear push out force.

14. An engine starting device according to claim 1, wherein the pinion unit includes, in place of including the pinion unit synchronization surfaces on all teeth on the distal end portions in the meshing axial direction of the pinion gear meshing with the ring gear, a configuration in which a tooth without the pinion unit synchronization surfaces is mixed in a part of the teeth.

15. An engine starting device according to claim 14, wherein the pinion unit has a configuration in which a tooth having the pinion unit synchronization surfaces and a tooth without the pinion unit synchronization surfaces are alternately mixed.
